(19) United States
(12) Patent Application Publication
(10) Pub. No.: US 2009/0018693 A1
(43) Pub. Date: Jan. 15, 2009

(54) Apparatus for Projecting an Optical Marking on the Surface of an Article

(75) Inventor: Kurt-Michael Zimmermann, Freiburg (DE)

Correspondence Address: THE WEBB LAW FIRM, P.C., 700 KOPPERS BUILDING, 436 SEVENTH AVENUE, PITTSBURGH, PA, 15219, US

(73) Assignee: Z-LASER OPTOELEKTRONIK GMBH, Freiburg (DE)

(21) Appl. No.: 11/777,581

(22) Filed: Jul. 13, 2007

(51) Int. Cl. G06F 19/00

(52) U.S. Cl. 700/166

(57) ABSTRACT

A device for the projection of an optical marking onto the surface of an object comprises a projection mechanism for the generation of a pencil of rays directed to the surface and a manipulation mechanism for said pencil of rays. In addition, the device comprises a data storage unit for the filing of a default surface geometry of the object and a measurement mechanism for recording actual position values of the surface. The measurement mechanism and the data storage unit are connected to a comparison mechanism for comparing the actual position values with the default surface geometry. The comparison mechanism is control-connected to the manipulation mechanism for controlling said manipulation mechanism depending on the result of the comparison.

### BACKGROUND OF THE INVENTION

1. Field of the Invention

The invention relates to a device for projecting an optical marking onto the surface of an object, comprising at least one projection mechanism for the generation of a pencil of rays directed to said surface and with at least one manipulation mechanism for said pencil of rays.

2. Description of Related Art

Such a device is disclosed in EP 1 054 286 A1. The device has a projection mechanism with a light source for generating a pencil of rays composed of light rays approximately parallelly oriented to each other. A manipulation mechanism, which has two deflection mirrors pivotably mounted about axes orthogonally oriented to each other for positioning the pencil of rays on various places on the surface of an object, is arranged in the beam path of the pencil of rays. The deflection mirrors are controlled by means of swivel drives so that a light spot projected by the pencil of rays on the surface of the object moves along the polygon train. A deflection speed of the pencil of rays of sufficient magnitude is selected so that the movement of the light spot is not visible to human eyes and so that the polygon train appears as a line. The device can be used, for example, to mark places on the object at which a machining is to take place and/or at which another object is to be positioned by an operator of the device. However, a disadvantage resides in said device in that the position of the polygon train projected on the surface will deviate from a prespecified position if the object is not positioned exactly in a designated position relative to the device and/or if the object has tolerances regarding its surface geometry. If the operator of the device fails to note these deviations, manufacturing tolerances and/or position deviations in the positioning of the other object will result during the machining of the object.

The object is therefore to create a device of the aforementioned nature that enables the user to easily recognize a possible deviation of the object from a prespecified default position and/or a possible deviation of the dimensions of the object from prespecified reference dimensions and/or take such deviations into account when machining the object to be marked or positioning an object.

### SUMMARY OF THE INVENTION

This object is achieved in that the device comprises a data storage unit for filing default position values describing a default surface geometry of the object and a measurement mechanism for recording actual position values of the surface, wherein said measuring mechanism and data storage unit are connected to a comparison mechanism for comparing the actual position values with the default position values, and wherein the comparison mechanism is control-connected to the manipulation mechanism for controlling said manipulation mechanism depending on the result of the comparison.

In an advantageous manner, possible deviations of the actual position values from the default position and/or default surface geometry can be detected and compensated with great precision and/or optically adapted to the object with the projection mechanism. The projection is thus used to represent and measure. Geometric errors, functional errors, and/or differences between default and actual values can be projected onto the surface in graphic and/or written form. The object can thus first be measured and then marked by means of the device. An object is to be understood as a thing and/or a living organism.

In an advantageous embodiment of the invention, a storage area for filing marking image data describing the optical marking in an object-fixed coordinate system is provided, wherein the comparison device has an output for displaying a relative position signal describing the position of the object-fixed coordinate system relative to the position of a projector-fixed coordinate system, wherein a transformation mechanism is provided that has a first input connected to the storage area for the marking image data for transforming said marking image data into the projector-fixed coordinate system and a second input connected to the output for the relative position signal, and wherein an output of the transformation mechanism is control-connected to the manipulation mechanism. In this manner, even if the position of the object deviates from a default position, the optical marking can be projected onto the object in the correct position relative to the object largely free of distortions and with the right dimensions. If the object is turned and/or displaced about a certain angle relative to an axis, the optical marking will be turned and/or displaced in a corresponding manner, in order to project it on the same place on the surface that it would be projected if the object were correctly oriented. The comparison mechanism and/or the transformation mechanism can also be achieved by a microcomputer in which a comparison and/or a transformation program is executed.

In a particularly advantageous embodiment of the invention, the measuring mechanism and the manipulation mechanism are connected to a mechanism for determining the angle of incidence of the pencil of rays on the surface of the object from the actual position values and an input signal of the manipulation mechanism, wherein the projection mechanism has an actuating element for adjusting the intensity of the pencil of rays, and wherein the actuating element is connected to a measurement signal output of the mechanism for determining the angle of incidence in order to adjust the intensity depending on said angle of incidence. The intensity of the pencil of rays can then always be adjusted so that the light spot projected on the object by said pencil of rays always has approximately the same brightness for the human eye at various angles of incidence and is thus easily legible. Preference is given to a higher intensity setting for an oblique incidence of the pencil of rays than for a perpendicular incidence of the pencil of rays on the surface. In a projection mechanism having a laser as a light source, preference is given to adjusting the beam output of the laser so that the object is irradiated with the maximum laser output authorized by the laser safety directives for the class of laser to be employed.

An advantage resides herein if the projection mechanism has an adjustment mechanism for adjusting the color of the pencil of rays, and if said adjustment mechanism for changing the color of the optical marking depending on the result of the comparison is control-connected to the manipulation mechanism. The optical marking can then be projected, for example, with green or red light onto the surface of the object, depending on whether the actual position values of the object fall within or outside of a prespecified tolerance range. The result of the comparison is thus easily legible from the object for the operator of the device. Obviously the projection mechanism can also be used to project the comparison result onto the object in numerical and/or graphic form.

In an advantageous embodiment of the invention, the manipulation mechanism is a deflection mechanism arranged in the beam path of the pencil of rays. The deflection mechanism in this embodiment can have one or a plurality of mirrors capable of being pivoted in directions orthogonally oriented to each other.

In an advantageous embodiment of the invention, the device has a plurality of arrangements consisting in each case of the manipulation mechanism and the projection mechanism. Each manipulation mechanism can deflect, for example, the beam path of a pencil of rays with different colors. In this manner complex polygons can be projected with long lines and/or onto large objects, and/or simultaneous projections can be represented in various colors and/or the projection can be made from various directions in order to avoid shading by the object.

In a preferred embodiment of the invention, the position measuring mechanism has a mechanism for generating a deflection angle signal for the deflection mechanism as well as at least one camera laterally offset therefrom, wherein said camera and said mechanism for generating the deflection angle signal for determining the actual position values from image signals of said camera, the deflection angle signal, and prespecified parameters for the relative position between said deflection mechanism and said camera are connected to a triangulation mechanism. The projection mechanism thus fulfills a dual function in that it serves to project an intense, highly visible optical marking onto the object as well as a reference mark (e.g., a point or a line) for the triangulation or for measuring the position and/or the surface geometry of the object. Preference is given to the camera with its optical axis inclined relative to the longitudinal axis of the pencil of rays.

An advantage resides in the position measurement mechanism having at least two cameras, which are laterally separated from each other and connected to a triangulation mechanism for determining the actual geometry values from image signals of said cameras and prespecified parameters for the position of said cameras relative to each other. The measurement precision for recording the actual position values of the optical marking is then independent of the positioning precision of the pencil of rays or the optical marking. During the measurement, the surface of the object is scanned by means of the pencil of rays, while image signals from the scanned surface sites are recorded with the cameras. Preference is given to the cameras with their optical axes being inclined relative to each other. The parameters for the relative positions of the cameras can be determined by measurement. If necessary, temperature fluctuation-induced alterations of the camera positions can compensated by computer. To this end, the device can have, if needed, a temperature sensor that is connected to an appropriate compensation mechanism.

In a practical embodiment of the invention, an image processing mechanism configured to define the position of the image of a light spot projected onto the object by the pencil of rays on a two dimensional image recording sensor is always integrated in the cameras, wherein the image processing mechanism is connected to a computer, which is configured to determine the position of the optical marking from the positions of the images and the parameters for the position of the cameras relative to each other. Because the image processing takes place in the cameras, the amount of data to be transmitted from the cameras to the microprocessor is reduced considerably. The microprocessor can be a standard PC.

In an advantageous embodiment of the invention, at least one camera is configured as a camera cluster that has a plurality of two dimensional image recording sensors that are arranged to record images of various areas of the surface of the object and wherein preference is given to the allocation of imaging lenses in each case to said sensors. Here it is even possible for the images recorded by the image recording sensors to overlap partially. The image recorded from the surface of the object is then assembled from a plurality of partial images. In this manner, a high imaging or measurement precision can also be achieved with less expensive, standard image recording sensors.

In a practical embodiment of the invention, the device has a mechanism for the material machining of the object, wherein said mechanism is control-connected to the comparison mechanism for altering the object depending on the result of the comparison. The object can then be automatically provided with a marking, from which it is possible to determine whether the dimensions of the object lie within or outside of a prespecified tolerance range.

An advantage resides in the material machining being a laser material machining mechanism, particularly a marking device. The comparison result can then be more readily noted on the object.

Preference is given to the device having fastening places for connection to a building element, particularly a ceiling. The device can than be easily installed on a ceiling by means of a mounting and/or machining table. The device can also stand on a table as a stand alone compact device, e.g., in an incoming materials inspection department (3D incoming components inspection).

### BRIEF DESCRIPTION OF THE DRAWINGS

An illustrative embodiment of the invention is explained in more detail with reference to the drawing, wherein:

FIG. 1 shows a first illustrative embodiment of a device for projecting an optical marking onto the surface of an object and for measuring said surface of said object,

FIG. 2 shows the device in a calibration mode, and

FIG. 3 shows a second illustrative embodiment of the device.

### DESCRIPTION OF THE PREFERRED EMBODIMENTS

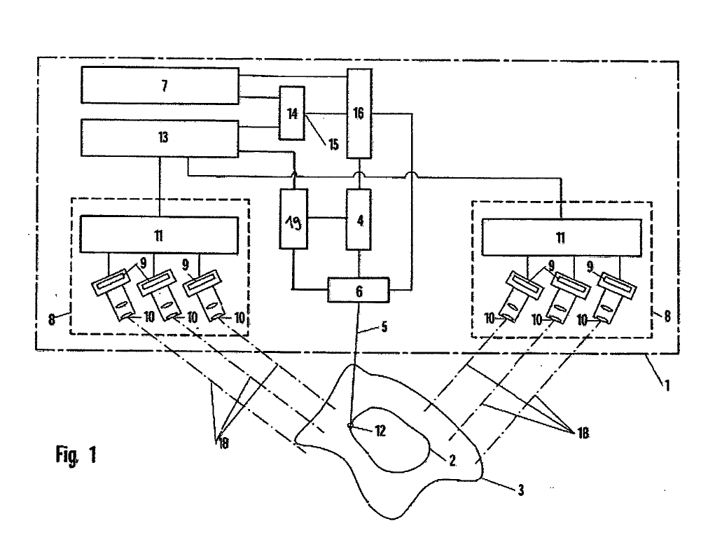

A device designated in its entirety by 1 in FIG. 1 for projecting an optical marking 2 onto the surface of an object 3 has a projection mechanism 4 for generating a pencil of rays 5. Said projection mechanism 4 comprises a semiconductor light source, such as a laser or light-emitting diode, and projection lenses arranged in the emission zone of said light source to group the light emitted from said light source into a pencil of rays 5 comprising light beams approximately parallelly oriented to each other.

A manipulation mechanism 6, which has a deflection mirror capable of being pivoted about two axes perpendicular to each other, is arranged in the beam path of the pencil of rays 5. Said deflection mirror is capable of being pivoted by means of a servo drive in order to position said pencil of rays 5 on various places of the object 3. Another suitable beam deflection unit, such as, e.g., an acoustooptical deflector or a biaxial microscanner, can be provided in lieu of the deflection mirror.

In addition, the device has a microcomputer with a data storage unit 7, in which a plurality of default position values that describe a default surface geometry of the object 3 are filed. The default surface geometry is selected so that it has no rotary and/or translatory degrees of freedom.

In addition, marking image data that define the optical marking in an object-fixed coordinate system are filed in the data storage unit. The marking image data can comprise coordinates of image points and/or lines saved as vectors for a polygon train. The data storage unit 7 is connectable to a CAD device from which the default position values are transferable to said data storage unit 7 via an interface, which is not shown in any greater detail in the drawing.

For recording the actual position values of the surface of the object 3, the device 1 has a measuring mechanism, which comprises two camera clusters 8 laterally separated from each other. Each camera cluster 8 has a plurality of two dimensional image recording sensors 9, to which imaging lenses 10 are allocated in each case. Said image recording sensors 9 and said imaging lenses 10 are oriented to the surface of the object 3 in order to record images thereof. The imaging lenses 10 of the individual camera clusters 8 are always arranged with their optical axes 18 parallel to each other. However, other embodiments of the invention in which the optical axes of the imaging lenses 10 can be inclined at an angle to each other and/or in which the measurement areas of the individual cameras overlap are also conceivable. The imaging lenses 10 of various camera clusters 8 are inclined at an angle relative to each other. The projection mechanism 4, the camera clusters 8, and the manipulation mechanism 6 are arranged in a set, prespecified position relative to each other on a beam, which can be an aluminum precision profile and which is not shown in any greater detail in the drawing.

An image processing mechanism 11, which is designed to define the position on the image recording sensors 9 of the image of a light spot 12 projected by the pencil of rays 5 onto the object 3, is always integrated in the camera clusters 8. The image processing mechanisms 11 are connected to a triangulation mechanism 13, which determines the position of the light spot 12 from the positions of the images of said light spot 12 and the parameters for the relative positions of the camera clusters 8. For the three dimensional measurement of the surface of the object 3, the light spot is positioned on a plurality of places on the surface corresponding to a dot matrix by using the manipulation mechanism 6, wherein actual position values are always defined for these places. The displaced light spot can project a continuous or interrupted, e.g., dotted line on the object 3.

However, it is also possible to project an annular optical marking, such as a circle, onto the object 3. Said annular marking as a rule is more strongly reflected at the place at which it falls on an edge of the object than in the area of the remaining surface of the object. It is thus possible to detect the edge and to track the annular marking along the edge in order to measure the position of the object.

The actual position values thus obtained are transmitted to a comparison mechanism 14, which is connected to the data storage unit 7, for comparison with the default position values. With reference to the actual and default position values, said comparison mechanism 14 determines the position of the object-fixed coordinate system relative to a projector-fixed coordinate system. Said comparison mechanism 14 has an output 15 for a relative position signal, which describes the position of the object-fixed coordinate system relative to the position of a coordinate system allocated to the projection mechanism 4, which henceforth shall also be designated as “projector-fixed coordinate system.”

In order to position the optical marking correctly on the object 2 [sic], the marking image data are transformed by means of a transformation mechanism 16 into the projector-fixed coordinate system. Said transformation mechanism 16 has a first input connected to the storage area for the marking image data and a second input connected to the output 15 for the relative position signal. The manipulation mechanism 6 is controlled depending on the marking image data transformed into the projector-fixed coordinate system. To this end, a control input of the manipulation mechanism 6 is connected to an output of the transformation mechanism 16. The pencil of rays 5 is projected onto the object 3 in such a way that the optical marking 2 is largely independent of the position of the object 3 relative to the projection mechanism 4, as long as the surface section to be marked of the object 3 is located in the projection range of the projection mechanism 4.

Furthermore, by comparing the actual position values with the default position values it is possible to detect deviations of the actual geometry of the object 3 from a default geometry and project them in graphic and/or written form onto the object 3 by means of the pencil of rays 5. In this manner, manufacturing tolerances, for example, can be visualized. Obviously, however, the detected deviation in the geometry can also be displayed in other ways.

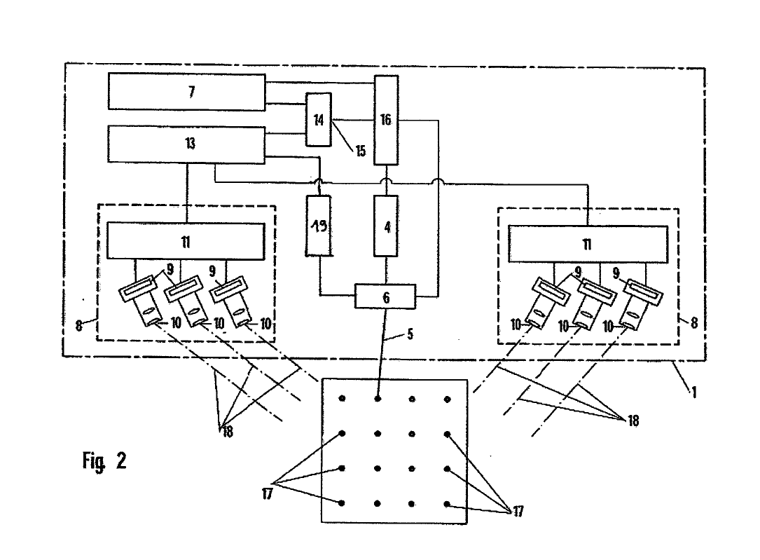

The parameters for the relative position of the camera clusters 8 can be defined by calibration based on photogrammetric calculation and then used for a plurality of measurements. As can be discerned in FIG. 2, preference is given to circular calibration markings 17 being positioned in the projection range on positions known beforehand when calibrating the device 1. Images of the calibration markings 17 are recorded by means of the camera clusters 8. With reference to the image data thus obtained, the very precisely known position of the camera clusters relative to the projection mechanism 4 and to the calibration projection plane as well as to the known position and/or dimensions of the calibration markings 17, the parameters are defined and then filed in the data storage unit 7.

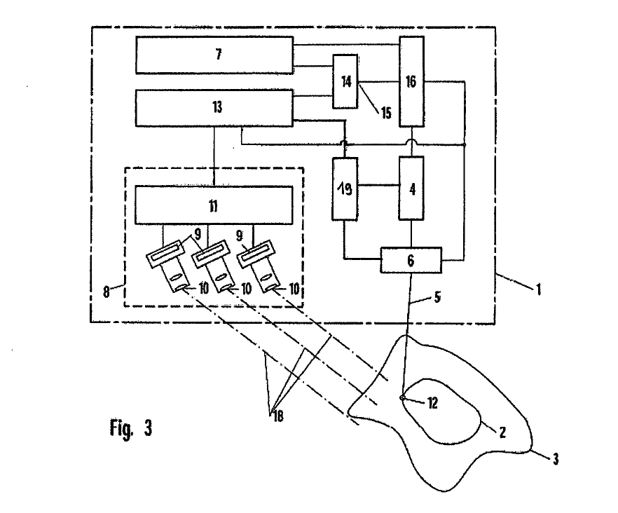

FIG. 3 shows a second illustrative embodiment of the device 1, in which the measurement mechanism has only one camera cluster 8. The image processing mechanism 11 of the camera cluster 8 is connected to a first input of the triangulation mechanism 13. A second input of the triangulation mechanism 13 is connected to the control input of the manipulation mechanism 6. The position of the light spot 12 is detected by means of the images recorded with the camera cluster 8, the signal applied to the control input of the manipulation mechanism 6, and by means of parameters that define the position of the camera cluster 8 relative to the projection mechanism 4.

It can be discerned in FIGS. 1 through 3 that an output for the actual position values of the triangulation mechanism 13 and an output for an input signal of the manipulation mechanism 6 are connected to a mechanism 19 for defining the angle of incidence of the pencil of rays 5 on the surface of the object 3. From the measured geometry of the object 3, the current deflection angle of the manipulation mechanism 6, and prespecified parameters for the position of the projection mechanism 4 and the manipulation mechanism 6, the mechanism 19 in each case detects the angle under which the pencil of rays 5 strikes the surface of the object 3. A measurement signal output of the mechanism 19 is connected with an actuating element of the projection mechanism 4, which element is not shown in any greater detail in the drawing, for adjusting the intensity of the pencil of rays 5 depending on the angle of incidence. If the pencil of rays 5 strikes the surface diagonally, e.g., under a 45□ angle, a higher intensity will be set than for an orthogonal incidence of the pencil of rays 5 on the surface.

It should be mentioned that a single camera can also be provided in lieu of a camera cluster.

The device 1 for projecting an optical marking 2 onto the surface of an object 3 therefore has a projection mechanism 4 for generating a pencil of rays 5 directed to the surface and a manipulation mechanism for said pencil of rays 5. In addition, the device 1 has a data storage unit 7 for filing a default surface geometry of the object 3 and a measurement mechanism for recording actual position values of the surface. Said measurement mechanism and said data storage unit 7 are connected to a comparison mechanism 14 for comparing the actual position values with the default surface geometry. Said comparison mechanism 14 is control-connected to the manipulation mechanism 6 for controlling the latter depending on the result of the comparison.

The invention claimed is:

1. A device for projecting an optical marking onto the surface of an object, comprising at least one projection mechanism for generating a pencil of rays directed to the surface and at least one manipulation mechanism for the pencil of rays, wherein said device has a data storage unit for filing default position values defining a default surface geometry of the object and a measurement mechanism for recording actual position values of the surface, that the measurement mechanism and the data storage unit are connected to a comparison mechanism for comparing the actual position values with the default position values, and that said comparison mechanism is control-connected to the manipulation mechanism for controlling said manipulation mechanism depending on the result of the comparison.

2. The device as in claim 1, wherein a storage area is provided in the data storage unit for filing marking image data describing the optical marking in an object-fixed coordinate system, that the comparison device has an output for displaying a relative position signal describing the position of the object-fixed coordinate system relative to the position of a projector-fixed coordinate system, that a transformation mechanism having a first input connected to the storage area for the marking image data and a second input connected to the output for the relative position signal is provided for transforming the marking image data into the projector-fixed coordinate system, and that an output of the transformation device is control-connected to the manipulation mechanism.

3. The device as in claim 1, wherein the measurement mechanism and the manipulation mechanism are connected to a mechanism for defining the angle of incidence of the pencil of rays on the surface of the object from the actual position values and an input signal of the manipulation mechanism, that the projection mechanism has an actuating element for adjusting the intensity of the pencil of rays, and that for adjusting the intensity depending on the angle of incidence said actuating element is connected to a measurement signal output of the mechanism for defining the angle of incidence.

4. The device as in claim 1, wherein the projection mechanism has an adjustment mechanism for adjusting the color of the pencil of rays, and that the adjustment mechanism is control-connected to the manipulation mechanism for adjusting the color of the optical marking depending on the result of the comparison.

5. The device as in claim 1, wherein the manipulation mechanism is a deflection mechanism arranged in the beam path of the pencil of rays.

6. The device as in claim 1, wherein said device has a plurality of arrangements consisting in each case of the manipulation mechanism and the projection mechanism.

7. The device as in claim 1, wherein the position measurement mechanism comprises a mechanism for generating a deflection angle signal for the deflection mechanism as well as at least one camera laterally separated therefrom, and that the camera and the mechanism for generating the deflection angle signal for defining the actual position values from image signals of the camera, from the deflection angle signal, and from prespecified parameters for the relative position between the deflection device and the camera are connected to a triangulation mechanism.

8. The device as in claim 1, wherein the position measurement device has at least two cameras laterally separated from each other, which are connected to a triangulation mechanism for defining the actual position values from image signals of the cameras and prespecified parameters for the position of the cameras relative to each other.

9. The device as in claim 1, wherein an image processing mechanism, which is designed to define the position of the image of a light spot on a two dimensional image sensor projected by the pencil of rays onto the object, is always integrated in the cameras, and that the image processing mechanism is connected to a computer, which is designed to define the position of the optical marking from the positions of the images and the parameters for the position of the cameras relative to each other.

10. The device as in claim 1, wherein at least one camera is configured as a camera cluster comprising a plurality of two dimensional image recording sensors, which are arranged to record images of various areas of the surface of the object and wherein preference is given to the allocation of imaging lenses in each case to said sensors.

11. The device as in claim 1, wherein said device has a mechanism for the material machining of the object, and that said mechanism is control-connected to the comparison mechanism for altering the object depending on the result of the comparison.

12. The device as in claim 1, wherein the material machining is a laser material machining mechanism, particularly a labeling mechanism.

13. The device as in claim 1, wherein said device has fastening areas for attachment to a building element, particularly a ceiling.
